(19) United States
(12) Patent Application Publication
(10) Pub. No.: US 2005/0077274 A1
(43) Pub. Date: Apr. 14, 2005

(54) Marking or engraving means applied over the external surface of meats in general and resulting product

(76) Inventor: Jose Barbosa Machado Neto, Sao Paulo (BR)

Correspondence Address: NOTARO AND MICHALOS, 100 DUTCH HILL ROAD, SUITE 110, ORANGEBURG, NY, 10962-2100, US

(21) Appl. No.: 10/686,288

(22) Filed: Oct. 15, 2003

(30) Foreign Application Priority Data
Oct. 10, 2003 (BR) PI0303043-1

(51) Int. Cl. B23K 26/00

(52) U.S. Cl. 219/121.68

(57) ABSTRACT

The present invention is directed to a marking or engraving means (1), automated (A) or manual, applied over the external surface (S) of meat (2) in general, meats as obtained in parts (2a), pieces/cubes (2b), slices (2c), milled portions (hamburgers, meatballs) (2d), sausages (2e) and/or any other form, meat (2) of any kind or origin (bovine, swine, poultry, fish, buffaloes, filled in natural and/or artificial tripes, and other kinds), in raw (refrigerated or frozen), baked, fried, cured, dried, smoke-dried state or others, originating or not from preparing stages (E), i.e. seasoned or not, which is forwarded to equipment or devices (3) producing calories or rays with appropriate intensity, preferably regulated by PLC, so that, according to the type of meat to be marked, engravings (4) in high or low relief are obtained, which can reproduce logos (L) and further technical information (T) on the surface (S) of said meat (2), enabling its recognition visually and/or by touch, by the consumer.

The present invention is directed to a marking or engraving means applied over the external surface of meats in general and resulting product, meats preferentially obtained in parts, pieces, slices, cubes, milled portions (hamburgers, meatballs), sausages or others of any kind or origin (bovine, swine, poultry, fish, buffaloes, filled in natural and/or artificial tripes, and other kinds), in raw, cooked, baked, fried, cured, dried, smoke-dried state or others, be them seasoned or not, and the present invention refers more specifically to means using equipment or devices producing calories or rays with appropriate intensity, automatically regulated according to the type of meat to be marked, aiming to engrave in high or low relief, reproducing logos and further technical information on the surface of said meat, enabling the marks effected to be recognized visually and/or by touch.

As known by both consumers and food product manufacturers in general, the existence of the most wide ranges of graphical indications on the product to be commercialized, such as logotype, origin, production batch, date of expiry, etc., is a mandatory condition, being them mostly applied to the packing of the product to be consumed or even by means of stamps, paper enclosures, plastics or any other appropriate means.

Producers are much worried to develop means to identify the product to be commercialized and, for that purpose, packs able to be kept for as long as possible next to the product have been developed, so to make the product trademark to remain shown for longer, but also aiming to keep all pertinent product information joint to it for longer, thus assuring consumer trustfulness.

Meats supplied in raw pieces or parts (refrigerated or frozen) present, for example, marks or identifiers applied by means of stamps with inks of different color, usually applied over areas with lower human consumption, such as fat covers. However, as known, besides the very bad esthetical appearance resulting, inks can contaminate the product and are fully non-hygienic.

Another model used to identify meats and similar, usually still in raw state, is the one using plastic elements, such as seals fastened onto the product itself, so to show its origin, performing the task of a certifying element; said seals must be taken off the product before the food is prepared, since they are made of material which is not resistant to heating while cooking or preparing.

It is known that, in the case of sausages or similar, packs are usually made of multiple-layer plastics, especially developed to protect the product from light rays and also from the paint from graphical printing, thus generating added costs to the product.

In the case of products sold as “ready dishes”, which are already seasoned and previously cooked/baked/fried, these are wrapped up in packs developed under the highest conservation and sterilization standards, which may or not be kept under refrigeration, also allowing their heating by microwave and general ovens.

The problem found in all kinds of identifiers as mentioned above is the fact that, once the product is taken off its respective package, seal or cover, be it for immediate consumption, be it to be later prepared, it starts to be exposed with no identification, i.e., once taken off the identifying means, it is no longer possible to identify its origin, producer, expiry and batch indications, etc., which can cause great trouble in case of refusals or returns by consumers or even distributors.

As a consequence of the above, and especially due to the current needs of the market over the so far existing state of the art, the applicant developed a marking or engraving means as applied over external surfaces of meats in general, with said means comprising more particularly an automatic or manual equipment provided with a heat producing device under adequate intensity, able to produce marks or engravings in low or high relief over at least one meat surface, making it to be recognized visually and/or by touch inside packs or during consumption.

One of the main purposes is therefore to make the commercialized meat to be provided with marks which can be recognized at any time, be it at the time purchase, being it wrapped up in a package or not, still during its consumption.

One of the preferential embodiments of the present invention consists of the fact that the marking or engraving can be done by means of laser ray applying devices, with wavelengths obtained by different components (gas, crystal, liquid, chemical reaction, etc.), being said rays previously regulated by PLC with or without monitoring sensors, which can be used, for example, to recognize the type of meat to be marked, its texture, grammage, and control printing tones, shapes, statements, figures and further information.

Another preferential embodiment to obtain the marks or engravings over the meat, as described by the present invention, it is made by means of an equipment provided with a hyper-heated metal head by means of resistance or equivalent, with said head getting close to the meat surface, touching it or not, so to mark its surface.

Once the meat is marked with all required information, it goes on to the following production stages, i.e. packing or direct distribution to consumers, and it may or not need refrigeration.

Therefore, the meat now contains all information for final consumers, assuring the trustfulness for the product trademark and furthermore, in case of a rejection by the consumer at the time of consumption, he or she can wrap up the product in any pack and take it to the distributor where it was purchased, or even contact the producer to be reimbursed, consequently causing all the chain round, i.e. to find out the problem causing said rejection. This can be extended to restaurants and similar, since all engravings can be found on the product to be consumed.

The marked or engraved meat as per the means as mentioned herewith allow the relation between manufacturer/distributor and consumer to be strengthened, since the offered product now shows the original mark on the product after the end of its consumption.

To compliment the present description so to obtain a better understanding of its features and according to a preferential practical embodiment, the description is followed by an attached set of figures, in which the following was represented as examples but in a non-limitative purpose:

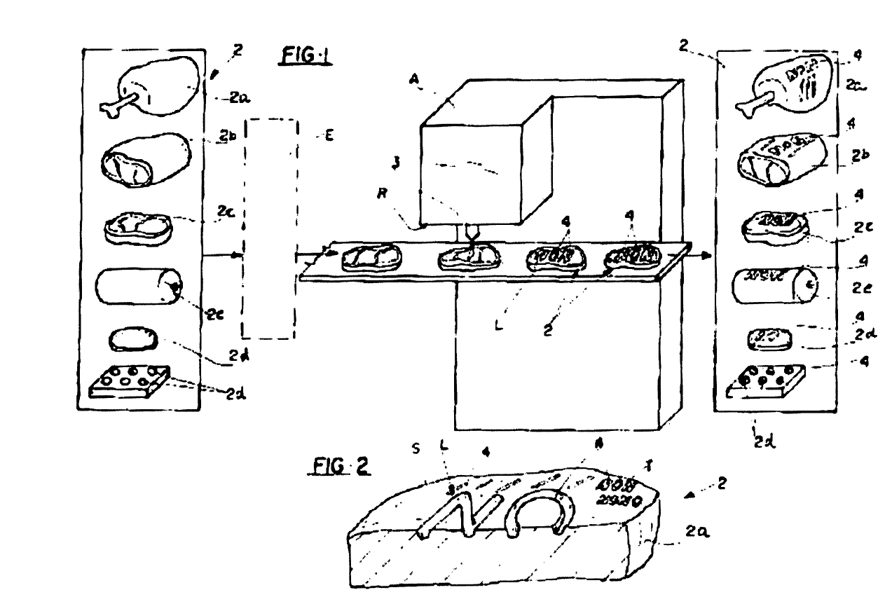

FIG. 1 shows an automatic mean to mark the external surface of the meat, including feeding the marking equipment with any kind of meat, be it prepared or not, engraving with the appropriate device and the obtained product.

FIG. 2 shows a schematic cut of the meat, as a symbolic slice, already marked by the mean as shown by the previous figure.

Concerning the illustrated figures, the present invention refers to a marking or engraving means applied over the external surface of meats in general and resulting product, the marking or engraving means (1) being automated (A) or manual and applied over the external surface (S) of meat (2) in general, meats as obtained in parts (2a), pieces/cubes (2b), slices (2c), milled portions (hamburgers, meatballs) (2d), sausages (2e) and/or any other form, meat (2) of any kind or origin (bovine, swine, poultry, fish, buffaloes, filled in natural and/or artificial tripes, and other kinds), in raw (refrigerated or frozen), baked, fried, cured, dried, smoke-dried state or others, originating or not from preparing stages (E), i.e. seasoned or not, which is forwarded to equipment or devices (3) producing calories or rays with appropriate intensity, preferably regulated by PLC, so that, according to the type of meat to be marked, engravings (4) in high or low relief are obtained, which can reproduce logos (L) and further technical information (T) on the surface (S) of said meat (2), enabling its recognition visually and/or by touch, by the consumer.

A marking or engraving mean can be embodied by means of devices applying laser rays (not shown), which wavelengths are obtained by different components (gas, crystal, liquid, chemical reaction, etc.), being said rays previously regulated by PLC with or without monitoring sensors (R), which can be used, for example, to recognize the type of meat to be marked, its texture, grammage, and control printing tones, shapes, statements, figures and further information, forming printings (4) in low or high relief.

Another way to obtain marks or engravings (4) over the meat (2), as described by the present invention, is made by means of an equipment provided with a hyper-heated metal head by means of resistance or equivalent, with the production of calories regulated to mark the meat surface as soon as getting close or touching it, forming engravings (4) in low or high relief.

Although the present invention is detailed, it is important to understand that it is application is not limited to the details and stages as described herewith. The present invention allows other modes and can be practiced or executed in a variety of modes. It should be understood that the terms used herein are for the purpose of description and not limitation.

1. A marking or engraving means applied over the external surface of meats in general and resulting product, in which the marking or engraving means (1), automated (A) or manual, engrave (4) in low or high relief over at least one of the external surfaces (S) of meat (2) of any kind, in any physical state and at any temperature, coming or not from preparing stages (E).

2. The marking or engraving means according to claim 1, in which the equipment (A) are provided with devices (3) producing calories or rays with appropriate intensity, regulated preferably by PLC, with or without sensor monitoring (R) to recognize the kind of meat to be marked, its texture and grammage, besides controlling printing tones, shapes, statements, figures and further information, forming engravings (4) in low or high relief.

3. The marking or engraving means according to claim 1, in which marking or printing can be done by means of devices (3) applying laser rays, which wavelengths are obtained by different components (gas, crystal, liquid, chemical reaction, etc.), being said rays previously regulated by PLC.

4. The marking or engraving means according to claim 1, in which the marking or engraving means can be made by devices (3) such as a hyper-heated metal head by means of resistance's or equivalent, with the production of calories regulated to mark the meat (2) surface (S) as soon as getting close or touching it, engraving (4) in low or high relief.

5. The resulting product according to claim 1, in which the meat (2) is obtained in parts (2a), pieces/cubes (2b), slices (2c), milled portions (hamburgers, meatballs) (2d), sausages (2e) and/or any other form.

6. The resulting product according to claim 1, in which the meat (2) is of any kind or origin (bovine, swine, poultry, fish, buffaloes, filled in natural and/or artificial tripes and other kinds).

7. The resulting product according to claim 1, in which the meat (2) enters the marking or engraving (4) equipment (A) under various physical states and temperatures (raw—refrigerated or frozen—, baked, fried, cured, dried, smoke-dried, etc.).

8. The resulting product according to claim 1, in which the meat (2) enters the marking or engraving (4) equipment (A) seasoned or not.

9. The resulting product according to claim 1, in which the meat (2) contains marks (4) in low or high relief reproducing logos (L) on the external surface (S).

10. The resulting product according to claim 1, in which the meat (2) contains marks (4) in low or high relief reproducing technical information (T) on the external surface (S).

11. The resulting product according to claim 1, in which the meat (2) contains marks (4) in low or high relief which may be recognized visually and/or by touch.
